(19) United States
(12) Patent Application Publication
(10) Pub. No.: US 2025/0128706 A1
(43) Pub. Date: Apr. 24, 2025

(54) Vehicle and Control Method Thereof

(71) Applicant: Hyundai Motor Company, Seoul (KR)

(72) Inventor: Jun Hyung Song, Hwaseong-si (KR)

(21) Appl. No.: 18/918,483

(22) Filed: Oct. 17, 2024

(30) Foreign Application Priority Data
Oct. 20, 2023 (KR) 10-2023-0141275

(51) Int. Cl. B60W 30/12

(52) U.S. Cl. CPC B60W 30/12; B60W 2554/20; B60W 2554/4041; B60W 2554/801

(57) ABSTRACT

A host vehicle includes a processor, and the processor is configured to determine, based on sensing information transmitted from a plurality of sensors, a virtual road on which the vehicle is traveling; and control, based on the virtual road and a driving state of the vehicle, an operation of a lane following assist (LFA) function of the vehicle.

### CROSS REFERENCE TO RELATED APPLICATION

This application claims the benefit of Korean Patent Application No. 10-2023-0141275, filed on Oct. 20, 2023, which is hereby incorporated by reference as if fully set forth herein.

### TECHNICAL FIELD

The present disclosure relates to a vehicle and a control method thereof.

### BACKGROUND

Vehicles with the ability to adaptively respond to surrounding situations that change in real time while driving may help reduce driver fatigue by performing driving, braking, and steering on behalf of drivers.

A vehicle may have at least one driving assistance function. The driving assistance function may include, for example, lane following assist (LFA).

LFA is a driving comfort feature that assists a driver in staying at or near a center of a lane while driving. LFA may also assist a driver in steering by recognizing lanes, for example, using a front camera, and steering for a predetermined period of time by recognizing vehicles ahead when lanes are not recognized.

However, LFA may not operate properly when a front camera fails to recognize lanes, but in exceptional cases, LFA may operate for a certain period of time by recognizing vehicles ahead even when the lanes are not recognized.

LFA may operate in a limited way when the front camera fails to recognize lanes due to contaminated lanes, darkness at night, or the like. For example, in a limited situation where lanes are not recognized during a normal operation of LFA, LFA may be deactivated and steering may not be controlled, resulting in a dangerous situation.

### SUMMARY

An object of the present disclosure is to provide a host vehicle and a control method thereof that, even in a limited situation where a front camera is not able to recognize lanes, may calculate a relative distance between the host vehicle and a nearby vehicle or object using at least one sensor and may generate a virtual lane based thereon, thereby ensuring operational maintainability of a lane following assist (LFA) function and expanding an operational range of the LFA function.

The technical objects to be achieved by the present disclosure are not limited to those described above, and other technical objects not described above may also be clearly understood by those skilled in the art from the following description.

According to one or more example embodiments of the present disclosure, a method performed by an apparatus of a vehicle may include: determining, based on sensing information transmitted from a plurality of sensors, a virtual road on which the vehicle is traveling; controlling, based on the virtual road and a driving state of the vehicle, an operation of a lane following assist (LFA) function of the vehicle. The virtual road is mapped to a road on which the vehicle is traveling.

The sensing information may include at least one of: a stationary object on the road, a second vehicle located in front of the vehicle, a third vehicle located diagonally in front of the vehicle, a fourth vehicle located diagonally behind the vehicle, a fifth vehicle located behind the vehicle, or a lateral distance relative to the vehicle.

Determining the virtual road may include determining, based on a driving trajectory of a second vehicle in front of the vehicle, a virtual lane on the virtual road.

The method may further include: determining, based on information about the second vehicle in front of the vehicle and based on a lateral distance of the second vehicle relative to the vehicle: a first width of the virtual lane, and a first curvature of the road; and determining, based on the first width of the virtual lane and based on the first curvature of the road, a first virtual line on the virtual road.

The method may further include: determining, based on information about an object on the road and based on a lateral distance of the object relative to the vehicle: a second width of the virtual lane, and a second curvature of the road; and determining, based on the second width of the virtual lane and based on the second curvature of the road, a second virtual line or a third virtual line on the virtual road.

The first virtual line may be determined prior to the determining of the second virtual line or the third virtual line.

The method may further include: adjusting, based on a third vehicle behind the vehicle and based on the object, a location and a curvature for each of the first virtual line, the second virtual line, and the third virtual line.

The first virtual line, the second virtual line, and the third virtual line may be determined further based on distance ratios different from each other with respect to the vehicle.

Determining the virtual road may include determining, based on an absence of any vehicles or objects on the road within an operational range of the plurality of sensors, the virtual road to be a straight road.

Controlling of the operation of the LFA function may include one of: deactivating, based on a determination that forward driving of the vehicle is not available, the LFA function; or maintaining, based on a determination that the forward driving of the vehicle is available, the LFA function activated.

According to one or more example embodiments of the present disclosure, a vehicle may include: one or more processors; memory storing instructions that are configured to cause, when executed by the one or more processors, the vehicle to: determine, based on sensing information transmitted from a plurality of sensors, a virtual road on which the vehicle is traveling; control, based on the virtual road and a driving state of the vehicle, an operation of a lane following assist (LFA) function of the vehicle. The virtual road may be mapped to a road on which the vehicle is traveling

The sensing information may include at least one of: a stationary object on the road, a second vehicle located in front of the vehicle, a third vehicle located diagonally in front of the vehicle, a fourth vehicle located diagonally behind the vehicle, a fifth vehicle located behind the vehicle, or a lateral distance relative to the vehicle.

The instructions may be configured to cause, when executed by the one or more processors, the vehicle to determine the virtual road by: determining, based on a driving trajectory of a second vehicle in front of the vehicle, a virtual lane on the virtual road.

The instructions may be configured to further cause, when executed by the one or more processors, the vehicle to: determine, based on information about the second vehicle in front of the vehicle and based on a lateral distance of the second vehicle relative to the vehicle: a first width of the virtual lane, and a first curvature of the road; and determine, based on the first width of the virtual lane and based on the first curvature of the road, a first virtual line on the virtual road.

The instructions may be configured to further cause, when executed by the one or more processors, the vehicle to: determine, based on information about an object on the road and based on a lateral distance of the object relative to the vehicle: a second width of the virtual lane, and a second curvature of the road; and determine, based on the second width of the virtual lane and based on the second curvature of the road, a second virtual line or a third virtual line on the virtual road.

The first virtual line may be determined prior to the second virtual line or the third virtual line being determined.

The instructions may be configured to further cause, when executed by the one or more processors, the vehicle to: adjust, based on a third vehicle behind the vehicle and based on the object, a location and a curvature for each of the first virtual line, the second virtual line, and the third virtual line.

The first virtual line, the second virtual line, and the third virtual line may be determined further based on distance ratios different from each other with respect to the vehicle.

The instructions, when executed by the one or more processors, may cause the vehicle to determine the virtual road by determining, based on an absence of any vehicles or objects on the road within an operational range of the plurality of sensors, the virtual road to be a straight road.

The instructions, when executed by the one or more processors, may cause the vehicle to control the operation of the LFA function by one of: deactivating, based on a determination that forward driving of the vehicle is not available, the LFA function; and maintaining, based on a determination that the forward driving of the vehicle is available, the LFA function activated.

### BRIEF DESCRIPTION OF THE DRAWINGS

FIG. 1 is a block diagram illustrating a host vehicle.

FIGS. 2, 3, and 4 are flowcharts illustrating a method of controlling a host vehicle.

FIGS. 5 and 6 are diagrams illustrating a method of generating a virtual lane and a virtual line.

### DETAILED DESCRIPTION

Hereinafter, embodiments of the present disclosure will be described in detail with reference to the accompanying drawings, and the same or similar elements will be given the same reference numerals regardless of reference symbols, and a repeated description thereof will be omitted. Further, when describing the embodiments, when it is determined that a detailed description of related publicly known technology obscures the gist of the embodiments described herein, the detailed description thereof will be omitted.

As used herein, the terms “include,” “comprise,” and “have” specify the presence of stated features, numbers, operations, elements, components, and/or combinations thereof, but do not preclude the presence or addition of one or more other features, numbers, operations, elements, components, and/or combinations thereof. In addition, when describing the embodiments with reference to the accompanying drawings, like reference numerals refer to like components and a repeated description related thereto will be omitted.

In addition, the terms “unit” and “control unit” included in names such as a vehicle control unit (VCU) may be terms widely used in the naming of a control device or controller configured to control vehicle-specific functions but may not be a term that represents a generic function unit. For example, each controller or control unit may include a communication device that communicates with other controllers or sensors to control a corresponding function, a memory that stores an operating system (OS) or logic commands and input/output information, and at least one vehicle controller that performs determination, calculation, selection, and the like necessary to control the function. The vehicle controller may also be referred to herein as a drive controller.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein. One or more features associated with autonomous driving control may be activated based on configured autonomous driving control setting(s) (e.g., based on at least one of: an autonomous driving classification, a selection of an autonomous driving level for a vehicle, etc.).

Based on one or more features (e.g., weight estimation features) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.).

One or more auxiliary devices (e.g., engine brake, exhaust brake, hydraulic retarder, electric retarder, regenerative brake, etc.) may also be controlled, for example, based on one or more features (e.g., weight estimation features) described herein. One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., weight estimation features) described herein.

Minimum risk maneuver (MRM) operation(s) may also be controlled, for example, based on one or more features (e.g., weight estimation features) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. A minimal risk maneuver may be an operation that may be activated during autonomous driving of the vehicle when a driver is unable to respond to a request to intervene. During the minimal risk maneuver, one or more processors of the vehicle may control a driving operation of the vehicle for a set period of time.

Biased driving operation(s) may also be controlled, for example, based on one or more features (e.g., weight estimation features) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane.

The driving control apparatus may identify a biased target lateral distance for biased driving control. For example, a biased target lateral distance may comprise an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc.

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., weight estimation features) described herein.

An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, etc.)

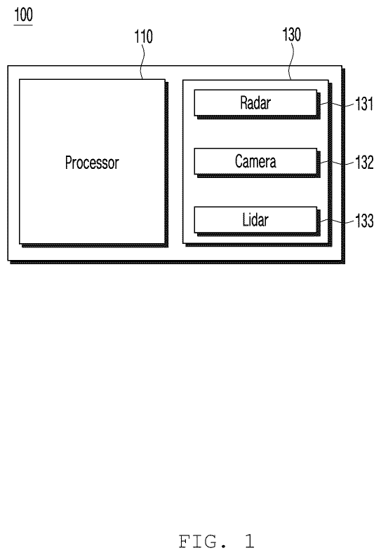

FIG. 1 is a block diagram illustrating a host vehicle according to an embodiment of the present disclosure.

Referring to FIG. 1, according to an embodiment, a host vehicle 100 may include a processor 110 and a plurality of sensors 130.

The plurality of sensors 130 may be sensors mounted on the host vehicle 100 or on the front, rear, and sides of the host vehicle 100. The plurality of sensors 130 may sense or detect, in real time, a surrounding situation of the host vehicle 100 that is parked or stopped or is traveling, and may provide sensing information to the processor 110.

For example, the plurality of sensors 130 may include a radar 131, a camera 132, a lidar 133, or the like. The radar 131 may also be referred to herein as a first sensor, the camera 132 may also be referred to herein as a second sensor, and the lidar 133 may also be referred to herein as a third sensor.

The radar 131 may be provided as one or more radars in the host vehicle 100. The radar 131 may measure a relative speed and a relative distance with respect to a recognized object, together with a wheel speed sensor (not shown) mounted on the host vehicle 100. For example, the radar 131 may be mounted at the front and on the front sides, and at the rear and on the rear sides of the host vehicle 100 to recognize objects in front of (or a “front object” herein) and behind (or a “rear object” herein) the host vehicle 100, and objects on the front sides (or a “front-side object” herein) (e.g., objects diagonally in front) and on the rear sides (or a “rear-side object” herein) of (e.g., diagonally behind) the host vehicle 100. An object diagonally in front of the vehicle may be located in front of the vehicle and in an adjacent lane. An object diagonally behind the vehicle may be located behind the vehicle and in an adjacent lane. The objects described herein may include objects installed on a road, or obstacles, vehicles, people, things, or the like present outside the host vehicle 100.

The camera 132 may be provided as one or more cameras in the host vehicle 100. The camera 132 may include, for example, a wide-angle camera. The camera 132 may capture images of objects present around the host vehicle 100 and their states and output image data based on the captured information. For example, the camera 132 may be mounted on at least one of the front, the sides, or the rear of the host vehicle 100 to recognize objects around the host vehicle 100. This will be described in detail below.

The lidar 133 may be provided as one or more lidars in the host vehicle 100. The lidar 133 may irradiate a laser pulse to an object, measure a time at which the laser pulse reflected from the object within a measurement range returns, sense information such as a distance to the object, a direction and speed of the object, or the like, and output lidar data based on the sensed information.

The processor 110 may receive the sensing information from the plurality of sensors 130, analyze road information about a road on which the host vehicle 100 is traveling to generate a virtual road, and determine a driving state of the host vehicle 100 based on the generated virtual road. The virtual road may map the road (e.g., a physical road) and may be an approximation or estimation of where the real road is located.

The processor 110 may select whether to expand an operation (e.g., expand an operational area) of a lane following assist (LFA) function based on a determined result. This will be described in more detail below.

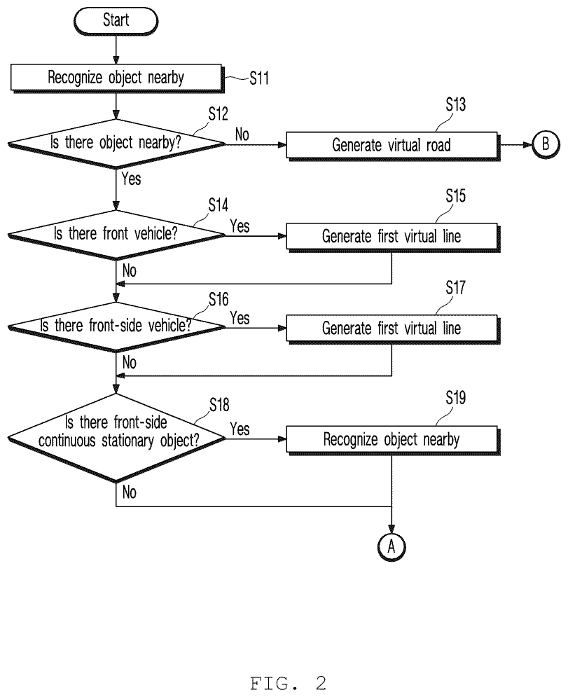

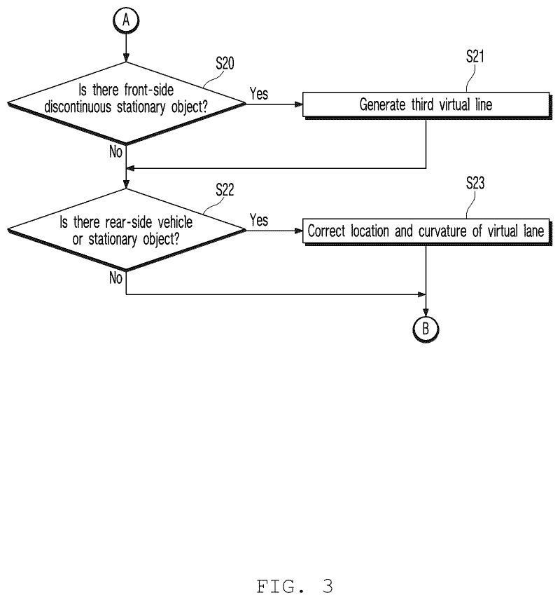

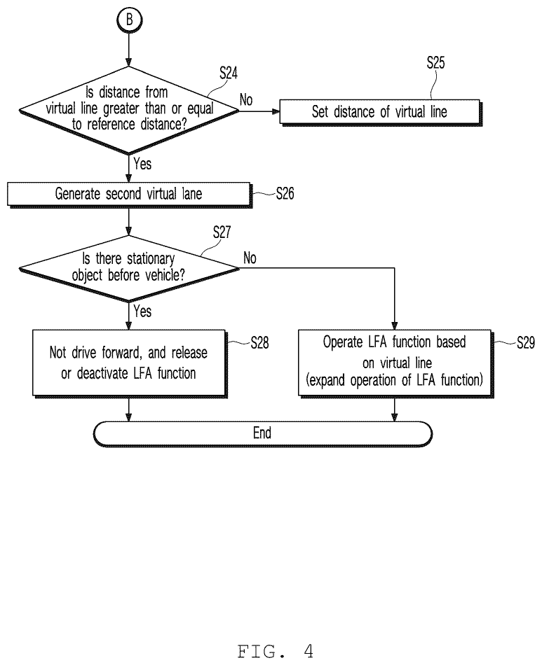

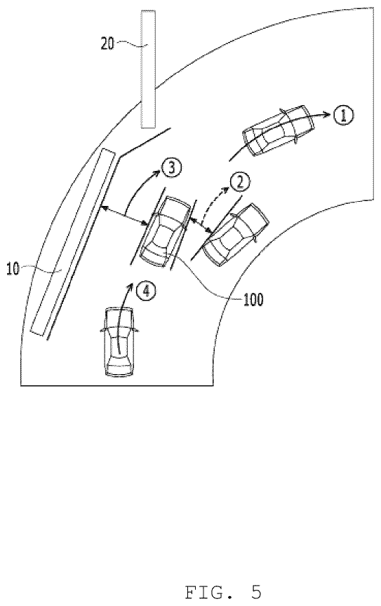

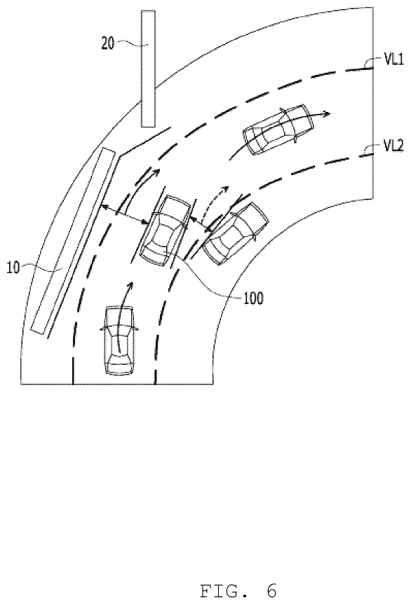

FIGS. 2 through 4 are flowcharts illustrating a method of controlling a host vehicle according to an embodiment of the present disclosure. FIGS. 5 and 6 are diagrams illustrating a method of generating a virtual lane and a virtual line according to an embodiment of the present disclosure.

Referring to FIGS. 2 through 6, a method of controlling a host vehicle according to an embodiment of the present disclosure is as follows.

First, under the control of the processor 110, the host vehicle 100 may receive sensing information from the plurality of sensors 130 and analyze road information about a road on which the host vehicle 100 is traveling. For example, the host vehicle 100 may recognize nearby objects or the like using a front radar, a side radar, or the like, under the control of the processor 110, in step S11. A nearby object may refer to an object that is located within a threshold distance away from the host vehicle 100. The nearby object may refer to an object that is recognized (e.g., detected, identified) within the operational range of one or more of the plurality of sensors 130. In this case, the road information may include a nearby object installed on the road, a front vehicle traveling before the host vehicle 100, a front-side vehicle traveling on the sides before the host vehicle 100, a rear-side vehicle traveling on the sides behind the host vehicle 100, a rear vehicle traveling behind the host vehicle 100, lateral information relative to the host vehicle 100, or the like. For example, the lateral information may indicate one or more lateral distances relative to the host vehicle 100.

For example, the host vehicle 100 may analyze the road information to determine the presence or absence of a nearby object and generate a virtual road based on the analysis, under the control of the processor 110.

For example, under the control of the processor 110, the host vehicle 100 may determine the presence or absence of a nearby object based on a result of the analysis in step S12 and, when no nearby object is recognized, may generate the virtual road centered on a current location of the host vehicle 100 in step S13. In this case, the host vehicle 100 may determine that the generated virtual road is a straight road, under the control of the processor 110.

That is, the host vehicle 100 may determine the virtual road to be a straight road, in the absence of a front vehicle, a front-side vehicle, a nearby object, and a rear vehicle on the road (e.g., based on an absence of any vehicles or objects on the road within an operational range the plurality of sensors 130) as the result of the analysis, under the control of the processor 110. In this case, the virtual road may be approximately 3 meters (m) in width.

Subsequently, under the control of the processor 110, when there is a front vehicle on the road as the result of the analysis in step S14, the host vehicle 100 may generate a first virtual lane on the virtual road based on a driving trajectory of the front vehicle in step S15.

For example, as shown in \textcircled{1} of FIG. 5, when there is a nearby object and a front vehicle, the host vehicle 100 may determine a center location and a travel path of the front vehicle and generate a first virtual lane based on the determined center location and travel path, under the control of the processor 110. In this case, the first virtual lane may be approximately 3 m in width.

Subsequently, under the control of the processor 110, when there is a front-side vehicle on the road as the result of the analysis in step S16, the host vehicle 100 may calculate a width of the first virtual lane and a curvature of the road using the front-side vehicle and the lateral information, and generate a first virtual line (e.g., VL2 in FIG. 6) on the virtual road based on the calculated width of the first virtual lane and the calculated curvature of the road in step S17.

For example, as shown in \textcircled{2} of FIG. 5, when there is a nearby object, a front vehicle, and a front-side vehicle, the host vehicle 100 may calculate a lateral distance to the front-side vehicle using sensing information, and may generate a first virtual line (e.g., VL2 in FIG. 6) on the virtual road using the width of the first virtual lane and the curvature of the road, based on the calculated lateral direction, under the control of the processor 110.

In this case, the first virtual line VL2 may be generated halfway between the front-side vehicle and the lateral distance. That is, the first virtual line VL2 may be generated with a distance between the host vehicle 100 and the front-side vehicle at a ratio of 5 to 5 in a lateral direction.

Subsequently, under the control of the processor 110, when there is a nearby object on the road as the result of the analysis, the host vehicle 100 may calculate a width of the first virtual lane and a curvature of the road based on the nearby object and the lateral information, and may generate a second virtual line (e.g., VL1 in FIG. 6) or a third virtual line on the virtual road based on the calculated width of the first virtual lane and the calculated curvature of the road.

As shown in FIG. 6, the nearby object may include a continuous stationary object 10 and a discontinuous stationary object 20. For example, the continuous stationary object 10 may include a guardrail, a tunnel, a barrier, a curb, or the like. The discontinuous stationary object 20 may include a streetlight, a sign, an undefined object, or the like.

For example, under the control of the processor 110, when there is a continuous stationary object (e.g., the continuous stationary object 10) on the road, as shown in \textcircled{3} of FIG. 5, as the result of the analysis in step S18, the host vehicle 100 may calculate a width of the first virtual lane and a curvature of the road based on the continuous stationary object 10 and the lateral information, and may generate a second virtual line (e.g., VL1 in FIG. 6) based on the calculated width of the first virtual lane and the calculated curvature of the road, in step S19.

In this case, the second virtual line may be generated with a distance between the host vehicle 100 and the continuous stationary object 10 at a ratio of 7 to 3 in a lateral direction.

In contrast, under the control of the processor 110, when there is a discontinuous stationary object (e.g., the discontinuous stationary object 20) on the road, as shown in \textcircled{3} of FIG. 5, as the result of the analysis in step S20, the host vehicle 100 may calculate a width of the first virtual lane and a curvature of the road based on the discontinuous stationary object 20 and the lateral information, and may generate a third virtual line based on the calculated width of the first virtual lane and the calculated curvature of the road in step S21.

In this case, the third virtual line may be generated with a distance between the host vehicle 100 and the discontinuous stationary object 20 at a ratio of 5 to 5 in a lateral direction.

As described above, the processor 110 may generate the first virtual line VL2, the second virtual line VL1, and the third virtual line by varying the distance ratio to the host vehicle 100, thereby contributing to more stable driving.

In addition, in a case where there are both a front-side vehicle and a nearby object, the host vehicle 100 may generate the first virtual line VL2 by preferentially considering the front-side vehicle over the nearby object, under the control of the processor 110.

That is, the host vehicle 100 may prioritize the front-side vehicle or side vehicle (which is present on the sides of the host vehicle 100) over the nearby object and generate the first virtual line VL2 in the middle of the lateral distance in the lateral direction, under the control of the processor 110. In this way, prioritizing the front-side vehicle traveling with the host vehicle 100 over a stationary nearby object may further improve the driving stability of the host vehicle 100.

Subsequently, under the control of the processor 110, when there is a rear vehicle within a preset reference distance on the road as the result of the analysis in step S22, the host vehicle 100 may correct a location and curvature of each of the first virtual line VL2, the second virtual line VL1, and the third virtual line generated with respect to the rear vehicle and a nearby object in step S23.

For example, as shown in \textcircled{4} of FIG. 5, the host vehicle 100 may correct the location, curvature, or the like of the first virtual line VL2, the second virtual line VL1, and the third virtual line generated with respect to the rear vehicle (or a rear-side vehicle) and the nearby object, under the control of the processor 110.

In this example, in a case where the rear vehicle is present far outside the preset reference distance, when correcting the location/curvature using the rear vehicle, the processor 110 may not apply a sudden change in curvature that changes in front of the rear vehicle. In consideration of this, the processor 110 may set a correction ratio to an error rate of 10% or less with respect to the first virtual line VL2, the second virtual line VL1, and the third virtual line. Accordingly, it may correct more accurately the location, the curvature, or the like of the first virtual line VL2, the second virtual line VL1, and the third virtual line.

As described above, the virtual road, the first virtual lane, the first virtual line VL2, the second virtual line VL1, and the third virtual line may change continuously. Based on this, the processor 110 may control the host vehicle 100 to update and change a virtual lane and a virtual line by considering, in sequential order, a front vehicle, a front-side vehicle, a front-side continuous stationary object, and a front-side discontinuous stationary object, when generating the virtual lane and the virtual line.

However, examples are not limited to the preceding, and the processor 110 may control the host vehicle 100 to update and change the virtual lane and the virtual line by moving to the next step when there is no vehicle or stationary object in the corresponding order.

As described above, even when the virtual lane and the virtual line are updated and changed in real time, the processor 110 may control the LFA function to follow the changed virtual lane and virtual line, not drastically but smoothly.

Further, when the first virtual lane is updated in a corresponding reference order, the processor 110 may control the LFA function to update only one of two left/right virtual lines relative to the host vehicle 100.

This is because, when the two left/right virtual lines are updated simultaneously with respect to the host vehicle 100, there is a high probability that an error may occur in the first virtual lane generated by predicting the road curvature and the lateral distance clearance based on the analysis of the lateral information.

To prevent this, the processor 110 may control the LFA function to update each time only one of the two left/right virtual lines with respect to the host vehicle 100.

Subsequently, under the control of the processor 110, the host vehicle 100 may determine whether a nearby object is only partially recognized, or whether a distance between the host vehicle 100 and the generated first to third virtual lines is maintained to be a predetermined distance in step S24. For example, when the predetermined distance between the host vehicle 100 and the generated first to third virtual lines is less than or equal to 0.5 m, the host vehicle 100 may set the distance to 0.5 m, under the control of the processor 110, in step S25. Based on this, the host vehicle 100 may generate a second virtual lane in step S26. The second virtual lane may be an updated virtual lane of the first virtual lane.

In contrast, when the predetermined distance between the host vehicle 100 and the generated first to third virtual lines is greater than or equal to 0.5 m in step S24, the host vehicle 100 may generate the second virtual lane based on this, under the control of the processor 110, in step S26.

Subsequently, the host vehicle 100 may determine a driving state of the host vehicle 100 based on the generated virtual road, under the control of the processor 110. The host vehicle 100 may select whether to expand the operation of the LFA function based on a result of the determination, under the control of the processor 110.

In this case, while determining the driving state of the host vehicle 100, when it is determined that the host vehicle 100 is unable to drive forward, the host vehicle 100 may deactivate the LFA function, under the control of the processor 110.

For example, under the control of the processor 110, the host vehicle 100 may generate the second virtual lane and, during the operation of the LFA function, may recognize a front continuous stationary object (e.g., a building, a streetlight, a sign, etc.) before the host vehicle 100 using a front camera and a front radar in step S27. In this case, when it is determined that the host vehicle 100 is unable to travel straight or a risk of collision is predicted, the host vehicle 100 may delete the generated second virtual lane or deactivate the LFA function in step S29.

In contrast, while determining the driving state of the host vehicle 100, when it is determined that the host vehicle 100 is able to drive forward, the host vehicle 100 may expand the operation of the LFA function based on the generated virtual road, under the control of the processor 110, in step S29. In this case, the host vehicle 100 may expand the operation (e.g., expand the operational area) of the LFA function by determining a lateral location and a heading angle of the host vehicle 100 on the virtual road, under the control of the processor 110.

As described above, under the control of the processor 110, the host vehicle 100 according to embodiments of the present disclosure may generate a virtual lane and a virtual line in consideration of the characteristics of a target object recognized by a radar sensor and may expand the operation of the LFA function based on this, thereby improving driving stability. For example, expanding the operational area of the LFA function may include analyzing an increased number of objects and vehicles in the surrounding area to create a virtual lane.

That is, under the control of the processor 110, the host vehicle 100 according to embodiments of the present disclosure may compensate for a limited situation where lanes are unrecognized by a front camera and may expand an operational area of the LFA function, thereby improving driving stability.

Further, under the control of the processor 110, the host vehicle 100 according to embodiments of the present disclosure may prevent the LFA function from being deactivated and maintain its normal operation in the event of a sudden lane loss from normal lanes during driving, thereby preventing a dangerous situation that may occur when the LFA function is deactivated and relieving the driver of the sense of difference that may be felt when the LFA function is deactivated.

Further, under the control of the processor 110, the host vehicle 100 according to embodiments of the present disclosure may prevent the LFA function from being deactivated and maintain its normal operation in the event of a sudden lane loss from normal lanes during driving, thereby utilizing a host driving function more accurately.

According to an example embodiment of the present disclosure, there is provided a method of controlling a host vehicle comprising a processor, the method comprising under control of the processor, generating a virtual road on which the host vehicle is traveling based on sensing information from a plurality of sensors, determining a driving state of the host vehicle based on the virtual road, selecting to expand an operation of a lane following assist (LFA) function based on a result of the determining, and controlling the vehicle based on the selecting.

The sensing information may include information about a nearby object stationary on the road, a front vehicle traveling before the vehicle, a front-side vehicle present on sides before the host vehicle, a rear-side vehicle present on sides behind the host vehicle, and a rear vehicle traveling behind the host vehicle, and lateral information set relative to the vehicle.

The method may include generating a first virtual lane on the virtual road based on a driving trajectory traveled by a front vehicle.

The method may include determining a first width of the first virtual lane and a first curvature of the road, using information about a front-side vehicle and lateral information set relative to the host vehicle, and generating a first virtual line on the virtual road based on the first width of the first virtual lane and the first curvature of the road.

The method may include determining a second width of the first virtual lane and a second curvature of the road, using information about a nearby object and lateral information set relative to the host vehicle, and generating a second virtual line or a third virtual line on the virtual road based on the second width of the first virtual lane and the second curvature of the road.

The first virtual line may be generated prior to a second virtual line or a third virtual line which is generated based on a nearby object.

The method may include correcting a location and a curvature for each of the first virtual line, the second virtual line, and the third virtual line based on a rear vehicle and the nearby object.

The first virtual line, the second virtual line, and the third virtual line may be generated with distance ratios different from each other with respect to the host vehicle.

The generating of a virtual road may include generating the virtual road as a straight road in the absence of a front vehicle, a front-side vehicle, a nearby object, and a rear vehicle.

The selecting to expand an operation of an LFA function may include deactivating the LFA function based on a determination that forward driving of the vehicle is not available, and expanding the operation of the LFA function based on a determination that the forward driving of the vehicle is available.

To solve the preceding technical problems, according to an embodiment of the present disclosure, there is provided an host vehicle including a processor, wherein the processor may be configured to generate a virtual road on which the host vehicle is traveling based on sensing information from a plurality of sensors, determine a driving state of the host vehicle based on the virtual road, select whether to expand an operation of a lane following assist (LFA) function based on a result of the determining, and control the host vehicle based on a result of the selection of whether to expand an operation of a LFA function.

The sensing information may include information about a nearby object stationary on the road, a front vehicle traveling before the host vehicle, a front-side vehicle present on sides before the host vehicle, a rear-side vehicle present on sides behind the host vehicle, and a rear vehicle traveling behind the host vehicle, and lateral information set relative to the host vehicle.

The processor may be further configured to generate a first virtual lane on the virtual road based on a driving trajectory traveled by 1 front vehicle.

The processor may be configured to determine a first width of the first virtual lane and a first curvature of the road, using information about a front-side vehicle and lateral information set relative to the host vehicle, and generate a first virtual line on the virtual road based on the first width of the first virtual lane and the first curvature of the road.

The processor may be configured to determine a second width of the first virtual lane and a second curvature of the road, using information about a nearby object and lateral information set relative to the host vehicle, and generate a second virtual line or a third virtual line on the virtual road based on the second width of the first virtual lane and the second curvature of the road.

The first virtual line may be generated prior to a second virtual line or a third virtual line which is generated based on a nearby object.

The processor may be configured to correct a location and a curvature for each of the first virtual line, the second virtual line, and the third virtual line based on a rear vehicle and the nearby object.

The processor may be configured to generate the virtual road as a straight road in the absence of the front vehicle, the front-side vehicle, the nearby object, and the rear vehicle.

The first virtual line, the second virtual line, and the third virtual line may be generated with distance ratios different from each other with respect to the host vehicle.

The processor may be further configured to deactivate the LFA function based on a determination that forward driving of the host vehicle is not available, and expand the operation of the LFA function based on a determination that the forward driving of the host vehicle is available.

The host vehicle and the control method configured as described above according to embodiments of the present disclosure may compensate for a limited situation where lanes are unrecognized by a front camera and may expand an operational area of the LFA function, thereby improving driving stability.

Further, the host vehicle and the control method configured as described above according to embodiments of the present disclosure may prevent the LFA function from being deactivated and maintain its normal operation in the event of a sudden lane loss from normal lanes during driving, thereby preventing a dangerous situation that may occur due to the deactivation of the LFA function.

Further, the host vehicle and the control method configured as described above according to embodiments of the present disclosure may prevent the LFA function from being deactivated and maintain its normal operation in the event of a sudden lane loss from normal lanes during driving, thereby relieving the driver of the sense of difference that may be felt due to the deactivation of the LFA function.

Further, the host vehicle and the control method configured as described above according to embodiments of the present disclosure may prevent the LFA function from being deactivated and maintain its normal operation in the event of a sudden lane loss from normal lanes during driving, thereby improving control performance.

Further, the host vehicle and the control method configured as described above according to embodiments of the present disclosure may compensate for a limited situation where lanes are unrecognized by a front camera and may expand an operational area of the LFA function, thereby utilizing a driving assistance function more accurately.

The effects that can be achieved from the present disclosure are not limited to those described above, and other effects not described above may also be clearly understood by those skilled in the art from the following description.

The embodiments of the present disclosure described herein may be implemented as computer-readable code on a medium in which a program is recorded. The computer-readable medium may include all types of recording devices that store data to be read by a computer system. The computer-readable medium may include, for example, a hard disk drive (HDD), a solid-state drive (SSD), a silicon disk drive (SDD), a read-only memory (ROM), a random-access memory (RAM), a compact disc ROM (CD-ROM), a magnetic tape, a floppy disk, an optical data storage device, and the like.

Accordingly, the preceding detailed description should not be construed as restrictive but as illustrative in all respects. The scope of the embodiments of the present disclosure should be determined by reasonable interpretation of the appended claims, and all changes and modifications within the equivalent scope of the present disclosure are included in the scope of the present disclosure.

What is claimed is:

1. A method performed by an apparatus of a vehicle, the method comprising:
determining, based on sensing information transmitted from a plurality of sensors, a virtual road on which the vehicle is traveling, wherein the virtual road is mapped to a road on which the vehicle is traveling; and
controlling, based on the virtual road and a driving state of the vehicle, an operation of a lane following assist (LFA) function of the vehicle.

2. The method of claim 1, wherein the sensing information comprises at least one of: a stationary object on the road, a second vehicle located in front of the vehicle, a third vehicle located diagonally in front of the vehicle, a fourth vehicle located diagonally behind the vehicle, a fifth vehicle located behind the vehicle, or a lateral distance relative to the vehicle.

3. The method of claim 1, wherein the determining of the virtual road comprises determining, based on a driving trajectory of a second vehicle in front of the vehicle, a virtual lane on the virtual road.

4. The method of claim 3, further comprising:
determining, based on information about the second vehicle in front of the vehicle and based on a lateral distance of the second vehicle relative to the vehicle:
a first width of the virtual lane, and
a first curvature of the road; and
determining, based on the first width of the virtual lane and based on the first curvature of the road, a first virtual line on the virtual road.

5. The method of claim 4, further comprising:
determining, based on information about an object on the road and based on a lateral distance of the object relative to the vehicle:
a second width of the virtual lane, and
a second curvature of the road; and
determining, based on the second width of the virtual lane and based on the second curvature of the road, a second virtual line or a third virtual line on the virtual road.

6. The method of claim 5, wherein the first virtual line is determined prior to the determining of the second virtual line or the third virtual line.

7. The method of claim 6, further comprising:
adjusting, based on a third vehicle behind the vehicle and based on the object, a location and a curvature for each of the first virtual line, the second virtual line, and the third virtual line.

8. The method of claim 6, wherein the first virtual line, the second virtual line, and the third virtual line are determined further based on distance ratios different from each other with respect to the vehicle.

9. The method of claim 1, wherein the determining of the virtual road comprises determining, based on an absence of any vehicles or objects on the road within an operational range of the plurality of sensors, the virtual road to be a straight road.

10. The method of claim 1, wherein the controlling of the operation of the LFA function comprises one of:
deactivating, based on a determination that forward driving of the vehicle is not available, the LFA function; or
maintaining, based on a determination that the forward driving of the vehicle is available, the LFA function activated.

11. A vehicle comprising:
one or more processors;
memory storing instructions that are configured to cause, when executed by the one or more processors, the vehicle to:
determine, based on sensing information transmitted from a plurality of sensors, a virtual road on which the vehicle is traveling, wherein the virtual road is mapped to a road on which the vehicle is traveling; and
control, based on the virtual road and a driving state of the vehicle, an operation of a lane following assist (LFA) function of the vehicle.

12. The vehicle of claim 11, wherein the sensing information comprises at least one of: a stationary object on the road, a second vehicle located in front of the vehicle, a third vehicle located diagonally in front of the vehicle, a fourth vehicle located diagonally behind the vehicle, a fifth vehicle located behind the vehicle, or a lateral distance relative to the vehicle.

13. The vehicle of claim 11, wherein the instructions are configured to cause, when executed by the one or more processors, the vehicle to determine the virtual road by:
determining, based on a driving trajectory of a second vehicle in front of the vehicle, a virtual lane on the virtual road.

14. The vehicle of claim 13, wherein the instructions are configured to further cause, when executed by the one or more processors, the vehicle to:
determine, based on information about the second vehicle in front of the vehicle and based on a lateral distance of the second vehicle relative to the vehicle:
a first width of the virtual lane, and
a first curvature of the road; and
determine, based on the first width of the virtual lane and based on the first curvature of the road, a first virtual line on the virtual road.

15. The vehicle of claim 14, wherein the instructions are configured to further cause, when executed by the one or more processors, the vehicle to:
determine, based on information about an object on the road and based on a lateral distance of the object relative to the vehicle:
a second width of the virtual lane, and
a second curvature of the road; and
determine, based on the second width of the virtual lane and based on the second curvature of the road, a second virtual line or a third virtual line on the virtual road.

16. The vehicle of claim 15, wherein the first virtual line is determined prior to the second virtual line or the third virtual line being determined.

17. The vehicle of claim 16, wherein the instructions are configured to further cause, when executed by the one or more processors, the vehicle to:
adjust, based on a third vehicle behind the vehicle and based on the object, a location and a curvature for each of the first virtual line, the second virtual line, and the third virtual line.

18. The vehicle of claim 16, wherein the first virtual line, the second virtual line, and the third virtual line are determined further based on distance ratios different from each other with respect to the vehicle.

19. The vehicle of claim 11, wherein the instructions, when executed by the one or more processors, cause the vehicle to determine the virtual road by determining, based on an absence of any vehicles or objects on the road within an operational range of the plurality of sensors, the virtual road to be a straight road.

20. The vehicle of claim 11, wherein the instructions, when executed by the one or more processors, cause the vehicle to control the operation of the LFA function by one of:
deactivating, based on a determination that forward driving of the vehicle is not available, the LFA function; and
maintaining, based on a determination that the forward driving of the vehicle is available, the LFA function activated.
